(19) United States
(12) Patent Application Publication
(10) Pub. No.: US 2004/0076376 A1
(43) Pub. Date: Apr. 22, 2004

(54) Optical fiber coupler and method of fabrication

(76) Inventor: Michael A. Pate, Corvallis, OR (US)

Correspondence Address: HEWLETT-PACKARD COMPANY, Intellectual Property Administration, P.O. Box 272400, Fort Collins, CO, 80527-2400, US

(21) Appl. No.: 10/274,168

(22) Filed: Oct. 17, 2002

(51) Int. Cl. G02B 6/36; G02B 6/26

(52) U.S. Cl. 385/50; 264/1.25; 216/94

(57) ABSTRACT

A method of fabricating a coupler for an optical fiber includes generating a beam of photonic energy and imaging a feature of the first mask onto the beam of photonic energy. The method also includes irradiating a substrate with the shaped beam, thereby ablating material from the substrate to create a feature. During the irradiating step, the shaped beam simultaneously irradiates the entire feature of the substrate.

### BACKGROUND OF THE INVENTION

In a modern communication system, optical fibers are often used to convey information between nodes in the system. At these nodes, as well as at other locations between these nodes, single and multimode optical fibers can be coupled end-to-end in a manner that aligns the optical axes of the end portions fibers so that communication signals can pass from a first section of fiber to a second section of fiber. Typically, this coupling requires that the optical axes of the two portions of the fibers be aligned to within a few microns to within a fraction of a micron. By coupling the end portions of the optical fibers to within these tolerances, a low-loss coupling joint can be formed, thus resulting in a reduced need for signal amplification between the nodes of the communications system. This, in turn, reduces the overall cost of the communication system.

When end portions of optical fibers are joined together, a sleeve or other splicing device may be used to align each of the end portions of the optical fibers. Generally, the splicing device is many times wider than the optical fiber. Thus, when a bundle that includes numerous optical fibers is joined together, the resulting bundle, which includes a splicing device for each individual optical fiber, can be cumbersome and unwieldy. Further, many types of splicing apparatus require substantial labor in order to precisely align the end portions of each optical fiber, thus increasing the cost to perform such optical fiber coupling.

### BRIEF DESCRIPTION OF THE DRAWINGS

FIG. 1 is a diagram of a system that performs a method of fabricating an optical fiber coupler in accordance with an embodiment of the invention;

FIG. 2 is a diagram of the mask, projection lens, and substrate of FIG. 1 in accordance with an embodiment of the invention;

FIG. 3 is an isometric view of an optical fiber coupler being used to couple two end portions of first and second optical fibers according to an embodiment of the invention;

FIG. 4 is a block diagram of a mask, projection lens, and substrate in accordance with another embodiment of the invention;

FIG. 5 is a block diagram of a mask, a corresponding summation pattern of individual point spread functions that results from the use of the mask, and a substrate in accordance with another embodiment of the invention;

FIG. 6 is a diagram of a mask having a substantially steep change in optical transmission according to and embodiment of the invention;

FIG. 7 is a diagram of a mask that can be used to fabricate the coupler of FIG. 3 according to and embodiment of the invention; and

FIG. 8 is a flowchart for a method of fabricating a coupler for an optical fiber according to an embodiment of the invention.

### DESCRIPTION OF THE EMBODIMENTS

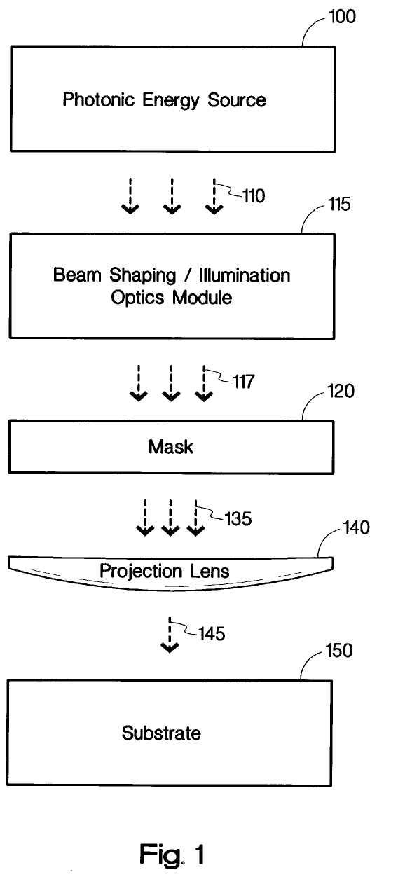

FIG. 1 is a diagram of a system that performs a method of fabricating an optical fiber coupler in accordance with an embodiment of the invention. In FIG. 1, photonic energy source 100 represents a source of photonic energy that produces photonic energy beam 110, which can be a laser beam, or other beam of photonic energy. In the embodiment of FIG. 1, photonic energy source 100 is an excimer laser that produces a coherent and collimated energy beam at a wavelength of 248 nm. However, other types of photonic energy sources including non-excimer lasers (for example solid state, gas, dye, and semiconductor lasers) that produce energy at multiple wavelengths from a single source can be also be used in the system of FIG. 1. Energy source 100 can also emit radiant energy in a broad spectrum, such as that generated by a Xenon lamp.

Photonic energy beam 110 is shaped and homogenized by way of beam shaping and illumination optics module 115 to form homogenized beam 117. Beam shaping and illumination optics module 115 can include an anamorphic beam expander, which increases the height and/or width of photonic energy beam 110. A beam homogenizer can then be employed to blend or otherwise make the photonic energy beam more uniform. For example, in the event that the beam emanating from source 100 possesses a Gaussian irradiance profile in a certain direction, the beam can be expanded and homogenized to normalize the power distribution, thus enabling homogenized beam 117 to possess a more uniform irradiance profile.

Homogenized beam 117 irradiates mask 120, which images or imparts the features of mask 120 onto the beam as the appropriate portions of the beam pass through the mask. Using the arrangement of FIG. 1, the irradiance pattern of resulting shaped beam 135 possesses a profile which, after being demagnified by projection lens 140, results in the ablation of material from substrate 150. The shape of the feature created in substrate 150 by the ablation accords with the irradiance pattern of shaped beam 135 as demagnified by the projection lens. Projection lens 140 serves to increase the irradiance of the energy beam incident on substrate 150 by an amount substantially equal to the reciprocal of the demagnifcation factor of the projection lens.

In an exemplary embodiment, projection lens 140 applies a magnification factor of 0.2. Thus, for this example, a feature of mask 120 being 10 microns wide in a first direction would imaged by projection lens 140, and results in the demagnified image feature being only 2 microns in the first direction. However, an alternate design of projection lens 140 can provide a greater or lesser amount of demagnification. The appropriate demagnification factor may be chosen to accommodate a different energy output from photonic energy beam 100, a difference in the size and features of mask 120, as well as changes in the material and size characteristics of substrate 150.

In the embodiment of FIG. 1, substrate 150 includes at least a substantial percentage of a polyimide material such as Kapton™. This material is suitable for use with photonic energy source 100 being an excimer laser that produces a coherent and collimated energy beam at a wavelength of 248 nm. In other embodiments, other materials such as polymers, ceramics, metals, thin metal films, silicon, and other materials may be used, perhaps in combination with a photonic energy source (100) in which the energy source is other than an excimer laser.

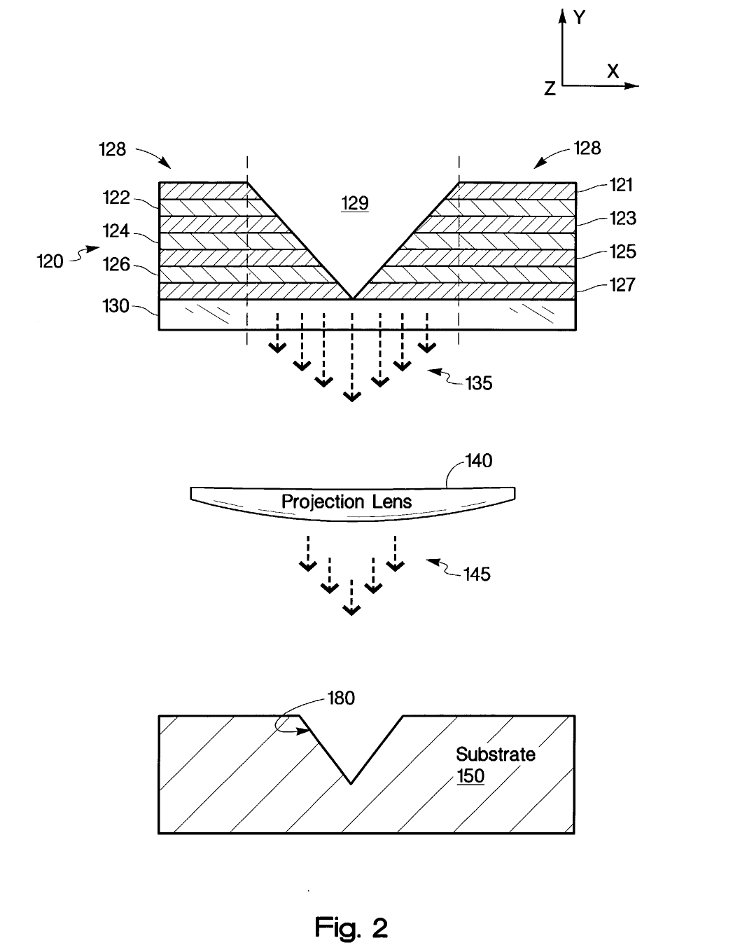

FIG. 2 is a diagram of the mask, projection lens, and substrate of FIG. 1 in accordance with an embodiment of the invention. In FIG. 2, region 128 of mask 120 includes quartz substrate (130) on top of which is placed alternating layers of material having first and second indexes of refraction. In the embodiment of FIG. 2, layers 121, 123, 125, and 127, and layers 122, 124, and 126 represent alternating layers of materials having substantially high and low indexes of refraction. Thus, in one embodiment, odd-numbered layers 121, 123, 125, and 127 possess a first index of refraction while even-numbers layers 122, 124, and 126 possess a second index of refraction, wherein the first index of refraction is substantially larger than the second index of refraction. In FIG. 2, substrate 130 is a transparent layer of quartz that forms the base of mask 120.

Further in the embodiment of FIG. 2, each layer (121-127) is of a vertical thickness that corresponds to one-quarter of the wavelength of photonic energy source 100, of FIG. 1. However, in other embodiments of the invention, the vertical thicknesses of each layer can be other fractions of the wavelength of the energy source. Thus, the combination of layers 121-127 provides a substantially high-reflection coating stack that does not allow significant photonic energy to pass through region 128 of mask 120.

Region 129 of mask 120 extends in a first (±z) direction, perpendicular to the x and y directions, and includes an area of a sloped optical transmission gradient in which a progressive number of layers 121-127 have been etched away in the ±x direction. Thus, as portions of photonic energy beam 110 from photonic energy source 100 pass vertically (in the −y direction) through region 129, a variable amount of energy from photonic energy beam 110 is allowed to traverse through the sloped optical transmission gradient that describes region 129. Therefore, in the area toward the center of region 129, nearly the full irradiance of photonic energy beam 110 passes through mask 120 and onto projection lens 140. Meanwhile, a smaller amount of energy passes vertically through region 129 and onto projection lens 140 at areas away from the center of region 129, approaching the boundary of region 129 with region 128. In this manner, the features of mask 120 are conferred or imparted onto photonic energy beam 110 to produce shaped beam 135.

Shaped beam 135 is then incident on projector lens 140. In the embodiment of FIG. 2, the features of mask 120 that are imaged onto shaped beam 135 are demagnified using projector lens 140 to form demagnified image 145. Demagnified image 145 represents a concentration of the energy in shaped beam 135 by way of the demagnification factor introduced by projection lens 140. Demagnified image 145 then used to irradiate substrate 150, which photoablates material from the surface of substrate 150 in a shaped pattern that corresponds to features of mask 120, including sloped optical transmission gradient region 129. Thus, the largest amount of material is ablated from substrate 150 in a region that corresponds to the center of region 129 of mask 120, thus forming the center portion of feature 180. Lesser amounts of material are ablated from other areas away from the center portion of feature 180, corresponding to the areas of region 129 closer to the interface of region 129 with region 128 of mask 120.

Although the example of FIG. 2 has included discussion of a mask, having seven layers (121-127), other applications may require the use of a mask that includes a greater or a lesser number of layers. Thus, some applications may require only one or two layers, while other applications may require more than 50 layers according to the thin film design and the optical transmission properties of the materials used to construct mask 120. Further, although region 129 shows a linear optical transmission gradient, in which the number of layers decreases linearly toward the center of region 129, other optical transmission gradient profiles may be used according to the features desired to be formed in substrate 150.

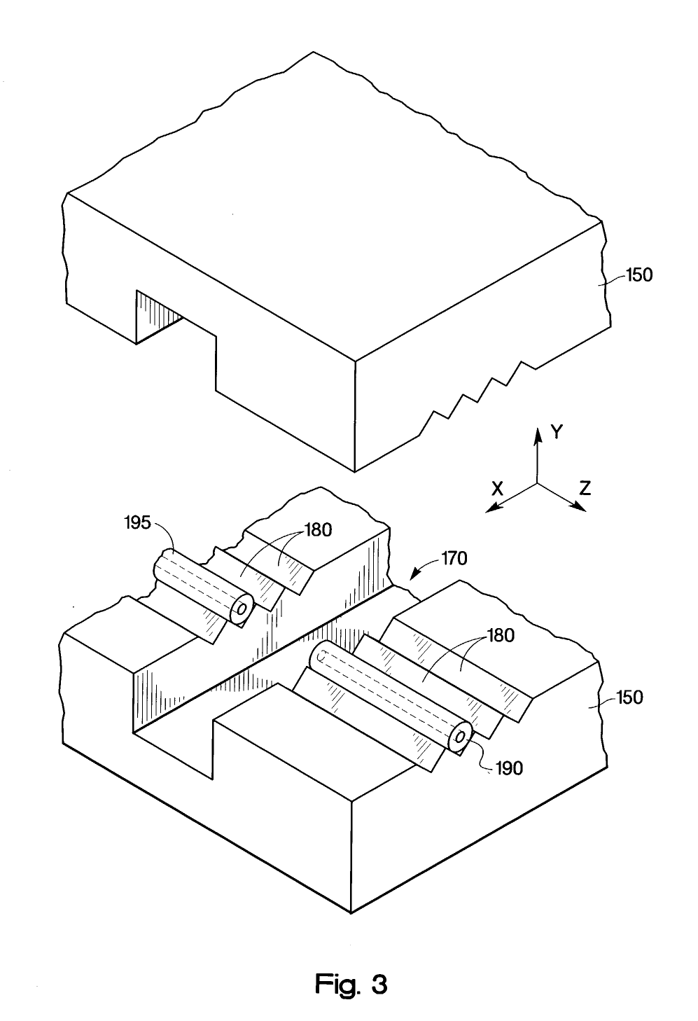

FIG. 3 is an isometric view of an optical fiber coupler being used to couple two end portions of an optical fiber according to an embodiment of the invention. In FIG. 3, substrate 150 is comprised mainly of Kapton™ and includes features 180, which extend in a first direction (±z) along optical fibers 190 and 195, and trench 170, which extends in a second direction (±x) that is substantially perpendicular or at least at a substantial angle to the direction of optical fibers 190 and 195. Each of features 180 is slanted downward in the second direction and then upward so that each feature has a first depth at a first location in the second direction and a second depth at a second location in the second direction. Thus, features 180 of FIG. 3 are shaped as a “V” groove. However, in other embodiments of the invention, each of features 180 can be shaped to accord with a portion of a polygon such as a trapezoid, hexagon, octagon, or any other closed plane figure bounded by straight lines. Further, feature 180 can include sidewalls that are curved in the shape of a parabola, or other conic section, or may be curved in accordance with another, perhaps higher order function.

In the embodiment of FIG. 3, one of features 180 may be formed by way of ablating material from substrate 150 using a mask having features that accord with the features of mask 120 of FIG. 2. Thus, one of features 180 (wherein a feature includes the portions of the feature on the two sides of trench 170) may be formed by way of a single exposure of photonic energy from photonic energy source 100 of FIG. 1. In other embodiments, mask 120 of FIG. 2 includes additional features, such as two or more optical transmission gradient regions (such as that described by region 129) so that a single exposure of energy from photonic energy source 100 produces two or more of features 180. In another embodiment, mask 120 of FIG. 2 includes a transparent region that runs perpendicular to region 129 (in the ±x direction) with a steep opaque-to-translucent region transition, so as to produce trench 170 of substrate 150. Other embodiments of the invention may include a trench that does not run in a direction perpendicular to features 180, but instead runs at an angle that is less than 90 degrees.

In the embodiment of FIG. 3, at least an entire one of features 180 is fabricated by way of a single exposure to photonic energy source 100. In the context of the embodiment of FIG. 3, a single exposure may include a single timed exposure to a continuous-wave photonic energy source. Alternatively, a single exposure may include an exposure to one or more pulses from a pulsed photonic energy source. Thus, feature 180 can be formed with very little change in the depth (±y direction), size (±x direction), or other characteristic of each one of features 180. Thus, if it is desired that each one of features 180 be of a depth of no more than 20 microns, each of features 180 can be formed to accord with this depth. Further, in the event that mask 120 includes some surface, material, or other defect that causes a nonuniformity in the irradiance pattern of the shaped beam, the effect of the nonuniformity can be reduced by the demagnification property of projection lens 140. Thus, in the event that mask 120 includes a nonuniformity that could bring about a one micron defect in the lateral position of one of features 180, a 5:1 demagnification factor brought about by projection lens 150 can reduce the defect on substrate 150 from 1 micron to 0.2 microns.

In FIG. 3, fiber optic cable end portions 190 and 195 are laid into one of features 180 and separated by trench 170. Trench 170 provides a means of inserting an index-matching coupling adhesive that bonds end portions 190 and 195 to one another. In the event that the coupling agent does not include an adhesive property, the adhesive can be placed within both sides of feature 180. Trench 170 can also be used to insert an optical switch or optical circuit element that improves the coupling between end portions 190 and 195. An example of such a coupling element can be a ball lens such as a spherical ball lens used for fiber/laser coupling or collimation. Other examples of optical elements that can be placed within trench 170 are dichroic beam splitters and beam combiners, polarization control optics, diffractive structures, spectral filters, switches, or other suitable optical devices to perform optical switching techniques.

Further, a second one of substrate 150 (shown in the upper portion of FIG. 2) can be formed and used as a cover to be placed atop a first one of substrate 150. Substrate 150 can also include a hinge located between adjacent ones of features (180) that allows a portion of the substrate to be folded and rested atop end portions 190 and 195, thus restricting movement of the two end portions in yaw, pitch, and lateral translations. The hinge can also be placed at an area other than between adjacent ones of features 180 such as perpendicular to the features.

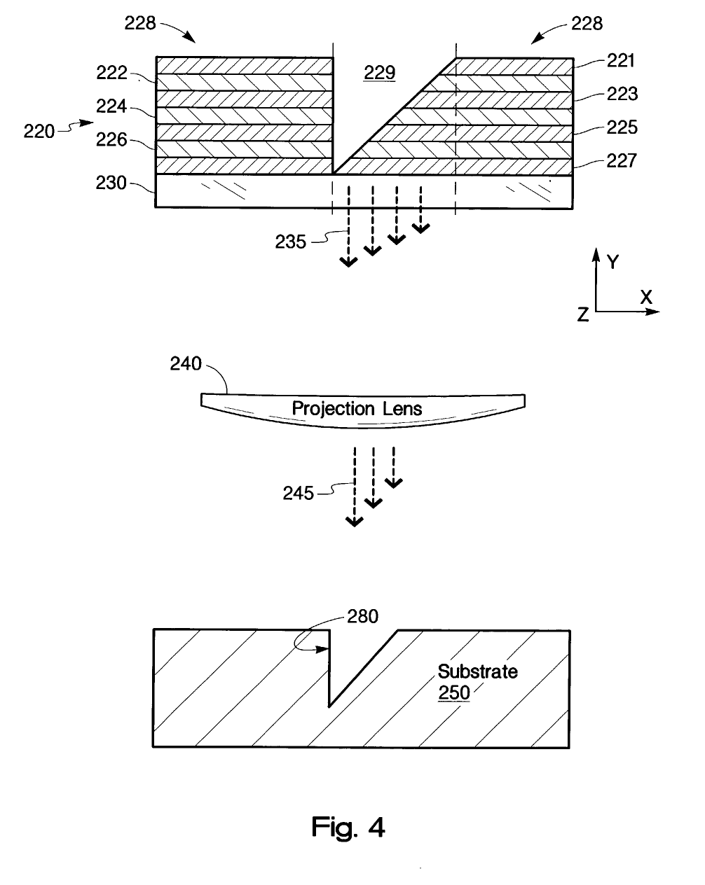

FIG. 4 is a block diagram of a mask, projection lens, and substrate in accordance with another embodiment of the invention. In the embodiment of FIG. 4, layers 221-227 represent layers of materials having alternating first and second indexes of refraction. Additionally, each of layers 221-227 (of region 228) may have a thickness equal to one-quarter of the wavelength of a photonic energy source, such as source 100 of FIG. 1. In an alternate embodiment, the thin films that comprise layers 221-227 can comprise thin film layers that include thicknesses other than one-quarter of the wavelength of photonic energy source 100.

As shown in FIG. 4, one side of region 229 includes a linear optical transmission gradient, while another side of the region includes a substantially steep change in the optical transmission of the mask. Thus, when mask 220 is irradiated by a beam of photonic energy, the irradiance pattern of resulting shaped beam 235 from mask 220 includes an area of high intensity near the region of the steep change in the optical transmission the mask, and an area of gradually lesser intensity brought about by the optical transmission gradient area of region 229. The mask features are then demagnified by way of projection lens 240 to form demagnified image 245. Demagnified image 245 is then used to irradiate substrate 250 and form feature 280, which corresponds to the general shape of region 229.

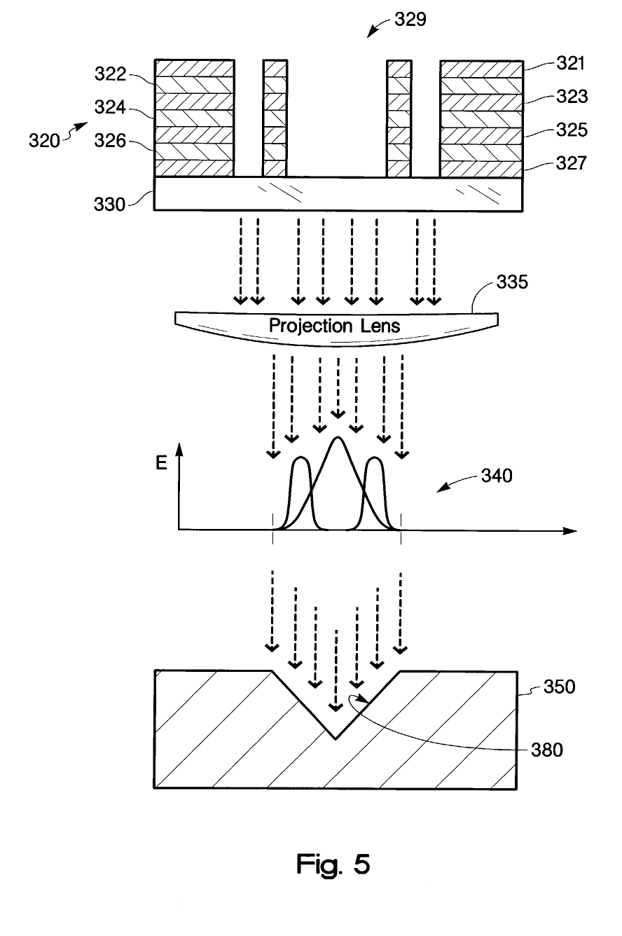

FIG. 5 is a block diagram of a portion of a system for fabricating a coupler for an optical fiber in accordance with another embodiment of the invention. The system of FIG. 5 includes mask 320, projection lens 335, a corresponding summation pattern of individual point spread functions (340) that results from the use of mask 320 and projection lens 335, and substrate (350). As a photonic energy beam passes vertically through the set of slits that defines region 329 and through projection lens 335, each slit produces an individual point spread function (340). When the summation of each of individual point spread functions 340 irradiates substrate 350, the summation pattern of the individual point spread functions ablates substrate 350 to form feature 380.

Although the embodiment of FIG. 5 shows only three slits etched in mask of 320, any number of slits can be used in order to produce an appropriate summation pattern of the individual point spread functions. Thus, other embodiments of the invention can include four, five, six, or more slits. Further, the spacing between each slit, as well as the width of each slit can also be optimized to produce a desired summation pattern, which, in turn, forms feature 380. Additionally, although mask 320 includes only layers 321-327, any number of layers of varying refractive indexes can be used.

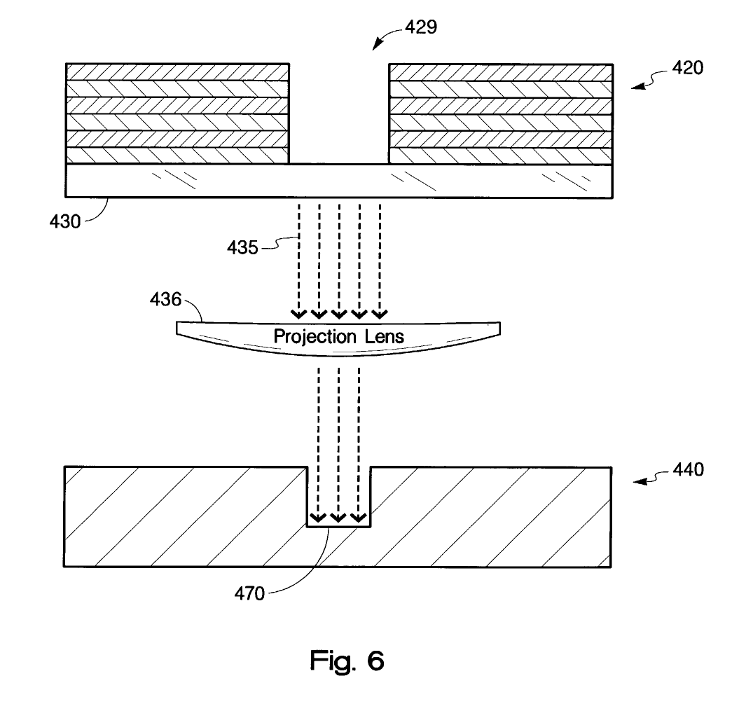

FIG. 6 is a diagram of a mask having a substantially steep change in the optical transmission according to an embodiment of the invention. Thus, as photonic energy beam 430 passes vertically through mask 420 and through projection lens 436, the point spread function which results from transparent region 429 produces feature 470. Feature 470 can be used as a trench, such as trench 170 of FIG. 3.

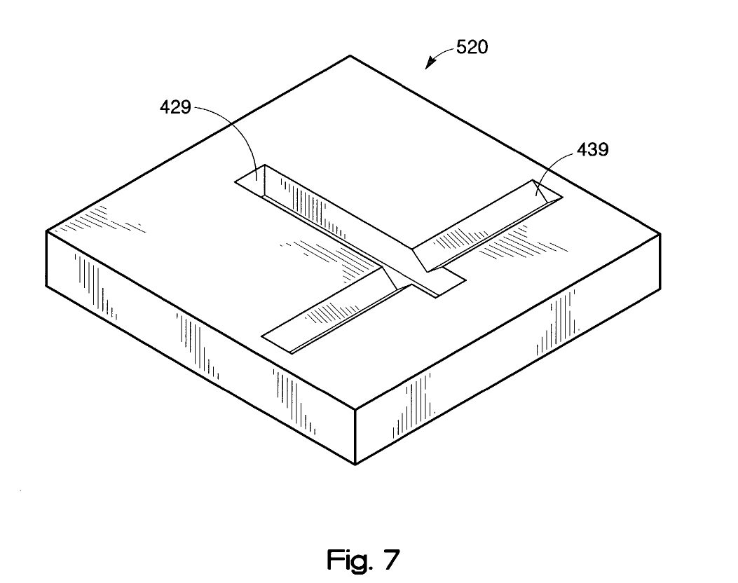

FIG. 7 is a diagram of a mask that can be used to fabricate the coupler of FIG. 3 according to an embodiment of the invention. In the diagram of FIG. 7, the scales of region 429 and region 439 of mask 520 are exaggerated. It is likely that actual embodiments of the invention features 429 and 439 would likely be much reduced in size relative to the overall size of the mask. Further, the thin film layers having varying indexes of refraction, such as layers 121-127 of FIG. 2, have not been shown for reasons of clarity.

The irradiance profile that results from the mask of FIG. 7 extends in a first direction along the length of an optical fiber as well as extending in a second direction that is at a substantial angle to the length of the optical fiber. In FIG. 7, region 429 represents an area of a substantially steep change in the optical transmission of the mask. Thus, a beam of photonic energy passing vertically through region 429 produces a trench, such as trench 170 of FIG. 3. Further, region 439, which includes an area of a sloped optical transmission gradient produces corresponding “V” shaped features, such as features 180 of FIG. 3. Embodiments of the invention can include other regions similar to region 439, thus producing additional “V” shaped grooves in a target substrate extending along a second direction. Although regions 429 and 439 are shown as being at right angles to each other, nothing prevents the regions being at an angle less than 90 degrees to each other.

In another embodiment of the invention, not all of the features of mask 520 are present in a single mask. Thus, region 439, may be the only feature present in the first mask, while a second mask may only include feature 429. In another embodiment of the invention, multiple features 439 can be present on mask 520.

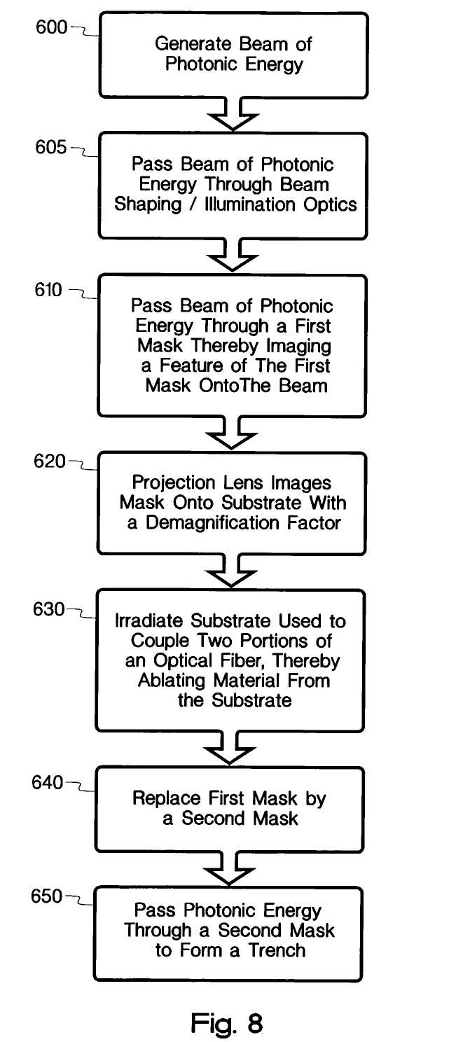

FIG. 8 is a flowchart for a method of fabricating a coupler for an optical fiber according to an embodiment of the invention. The method of FIG. 8 begins at step 600 in which a beam of photonic energy is generated. The beam of photonic energy preferably includes both coherent and substantially collimated light, such as that generated by an excimer laser, another type of laser, or another source of photonic energy. The method continues at step 605 where illumination and beam shaping optics homogenize and shape the beam, thus enabling the beam to possess a substantially uniform irradiance profile at the plane of a first mask.

The method continues at step 610, in which the beam of photonic energy is passed through a first mask, thereby imaging a feature of the first mask to form a shaped beam. These features can include a “V” shaped groove that extends lengthwise in a first direction along the length of an optical fiber. The feature can include an optical transmission gradient that gradually reduces the intensity of the beam of photonic energy in a second direction that is perpendicular or at least at a substantial angle to the length of the optical fiber, thereby forming the walls of a “V”.

The method continues at step 620 in which the mask is imaged onto a substrate by way of a projection lens that demagnifies the mask features according to a demagnification factor. The method also includes step 630, in which a portion of the substrate used to couple two portions of an optical fiber is irradiated by the shaped beam, thereby ablating material from the substrate. The method continues at step 640 in which the first mask is replaced by a second mask, wherein the second mask includes a feature, such as a trench, that runs in a second direction that is perpendicular to, or at least at a substantial angle to the first direction. At step 650, the beam of photonic energy is passed through the second mask and demagnified by the projection lens, wherein the second mask modifies the irradiance profile of the beam to accord with the shape of the trench.

Although the method of FIG. 8 has been described as including steps 600-650, some embodiments of the invention may include generating a beam of photonic energy (step 600), imaging the beam of photonic energy by way of a first mask to form a shaped beam (step 610), and irradiating a coupling portion of a substrate with the shaped beam, thereby ablating material from the substrate (step 630). In step 630, the shaped beam simultaneously irradiates the entire coupling portion of the substrate. Additionally, although the method of FIG. 8 includes replacing a first mask with a second mask, nothing prevents the first mask from incorporating more or even all of the features that are present on the second mask. Thus, the first mask may include one or more V-shaped features as well as the trench that separates the two sides of each feature.

In conclusion, while the present invention has been particularly shown and described with reference to the foregoing embodiments, those skilled in the art will understand that many variations may be made therein without departing from the spirit and scope of the invention as defined in the following claims. This description of the invention should be understood to include the novel and non-obvious combinations of elements described herein, and claims may be presented in this or a later application to any novel and non-obvious combination of these elements. The foregoing embodiments are illustrative, and no single feature or element is essential to all possible combinations that may be claimed in this or a later application. Where the claims recite “a” or “a first” element or the equivalent thereof, such claims should be understood to include incorporation of one or more such elements, neither requiring nor excluding two or more such elements.

What is claimed is:

1. A method of fabricating a coupler for an optical fiber, comprising:
generating a beam of photonic energy;
imaging a feature of a first mask onto the beam of photonic energy; and
irradiating a substrate with the beam of photonic energy, thereby ablating material from the substrate to form a feature of the substrate; wherein,
the beam of photonic energy simultaneously irradiates the entire feature of the substrate.

2. The method of claim 1, wherein the beam of photonic energy is a beam of coherent light.

3. The method of claim 1, wherein the beam of photonic energy is a beam of collimated light.

4. The method of claim 1, further comprising the step of demagnifying the feature of the first mask imaged onto the beam of photonic energy by way of a projection lens.

5. The method of claim 1, wherein the beam of photonic energy is a laser beam generated by an excimer laser.

6. The method of claim 1, wherein the feature of the substrate includes a length that accommodates a portion of the optical fiber.

7. The method of claim 6, wherein the first mask includes an optical transmission gradient that reduces the intensity of the beam of photonic energy in a direction that is at a substantial angle to the length of the portion of the optical fiber when the beam of photonic energy irradiates the substrate.

8. The method of claim 6, wherein the first mask includes a set of slits that brings about a summation pattern of individual point spread functions of each one of the set of slits, the summation pattern ablating material in a direction that is at a substantial angle to the length of the portion of the optical fiber when the beam of photonic energy irradiates the substrate.

9. The method of claim 1, additionally comprising the step of homogenizing the beam of photonic energy to produce a substantially uniform irradiance profile at the plane of the first mask.

10. The method of claim 1, further comprising the steps of:
replacing the first mask with a second mask that includes a trench, the trench running in a direction that is at a substantial angle to the feature of the first mask; and
imaging the trench onto the beam of photonic energy.

11. The method of claim 10, additionally comprising the step of ablating material from the substrate to form the trench in the substrate.

12. The method of claim 1, wherein the beam of photonic energy simultaneously irradiates the substrate to form the feature of the substrate as well as forming a trench in the substrate, the trench of the substrate running in a direction that is at a substantial angle to the length of the feature of the substrate.

13. A system for fabricating a coupler for an optical fiber, comprising:
a source that generates a beam of photonic energy;
a mask that receives the beam of photonic energy, the mask having at least one feature that extends in a first direction and one of an optical transmission gradient and a set of slits that brings about a summation pattern of individual point spread functions, the one of the optical transmission gradient and the set of slits extending in a second direction that is at a substantial angle to the first direction; and
a projection lens that receives the beam of photonic energy from the mask and images the beam of photonic energy onto a substrate, wherein;
the first direction corresponds to the direction along the length of the optical fiber being coupled by the coupler.

14. The system of claim 13, additionally comprising beam shaping and illumination optics that homogenize the beam of photonic energy to produce a substantially uniform irradiance profile.

15. The system of claim 13, wherein the beam of photonic energy ablates the substrate to form a feature on the substrate that accommodates the optical fiber.

16. The system of claim 15, wherein the feature on the substrate has a first depth at a first location in the second direction and a second depth at a second location in the second direction.

17. The system of claim 16, wherein the feature on the substrate that accommodates the optical fiber is shaped like a “V”.

18. The system of claim 16, wherein the feature on the substrate restricts movement of the optical fiber in yaw, pitch, and lateral translations.

19. The system of claim 13, wherein the source that generates the beam of photonic energy is an excimer laser.

20. The system of claim 13, wherein the mask includes at least one layer of a material having a first index of refraction and at least one layer of a material having a second index of refraction that is substantially lower than the first index of refraction.

21. The system of claim 13, wherein the mask includes alternating layers of material having first and second indexes of refraction and wherein the mask includes an optical transmission gradient having areas of decreasing numbers of alternating layers along the second direction, thereby changing, in the second direction, the amount of photonic energy that passes through the mask.

22. The system of claim 13, wherein the mask includes alternating layers of material having first and second indexes of refraction and wherein the mask includes a set of slits that brings about a summation pattern of individual point spread functions that extend in the second direction, the summation pattern having greater photonic energy at a first location in the second direction than at a second location in the second direction.

23. A system for fabricating an optical fiber coupler, comprising:
means for generating a beam of photonic energy; and
means for imparting mask features onto the beam of photonic energy to produce an irradiance profile that, when imaged onto a substrate, extends in a first direction that runs along the length of a portion of an optical fiber coupled by the optical fiber coupler, wherein;
the means for modifying the shape of the beam of energy includes means for producing an irradiance profile in a second direction, the second direction being at a substantial angle to the first direction.

24. The system of claim 23, wherein the means for generating a beam of photonic energy includes means for generating a laser beam.

25. An optical fiber coupler, comprising:
a substrate that includes at least one feature adapted to accommodate two end portions of an optical fiber, the substrate also having a trench cut at a substantial angle to the at least one feature.

26. The optical fiber coupler of claim 25, additionally comprising a cover, the cover including at least one feature adapted to accommodate the two end portions of the optical fiber and restrict movement of the two end portions of the optical fiber relative to each other.

27. The optical fiber of claim 26, wherein the cover additionally comprises a trench cut at a substantial angle to the at least one feature of the cover.

28. The optical fiber of claim 27, wherein the trench includes an optical element selected from the group consisting of a dichroic beam splitter and beam combiner, a polarization control element, a diffractive structure, a spectral filter, and a switch.
